(19) United States
(12) Patent Application Publication
(10) Pub. No.: US 2009/0062120 A1
(43) Pub. Date: Mar. 5, 2009

(54) Agrochemical Composition

(76) Inventors: Christian Sowa, Neustadt/Weinstrasse (DE); Michael Marcus Walter, Liederbach (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/085,560

(22) PCT Filed: Nov. 17, 2006
(86) PCT No.: PCT/EP2006/011037

§ 371 Date: Nov. 5, 2008

(30) Foreign Application Priority Data
Nov. 23, 2005 (DE) 10 2005 055 739.2

(51) Int. Cl. A01N 25/32; A01N 43/46; A01N 43/90; A01N 33/18; A01N 43/38; A01N 37/02; A01N 37/12; A01P 13/00; A01P 7/04; A01P 3/00; A01P 7/02; A01P 9/00; A01P 1/00

(52) U.S. Cl. 504/105; 514/788; 504/358; 504/103; 504/116.1; 504/241; 504/347; 504/284; 504/320; 504/313

(57) ABSTRACT

The invention relates to compositions containing, a) one or more agrochemical active ingredients, and b) one or more substances selected from caprolactam and caprolactam derivatives of formula (I), in which R represents H, acetyl, benzoyl, allyl, vinyl, methyl, ethyl, n-propyl, i-propyl, benzyl, a polyethylene glycol ether unit bonded by means of a C atom, comprising between 1 and 30, preferably between 1 and 10 and especially preferably between 1 and 6 ethylene glycol units, or a polypropylene glycol ether unit bonded by means of a C atom, comprising between 1 and 30, preferably between 1 and 10 and especially preferably between 1 and 6 propylene glycol units.

The present invention relates to agrochemical compositions comprising caprolactam and/or caprolactam derivatives.

In order to bring active agrochemical substances into solution a solvent used in numerous formulations to date has been N-Methyl-2-pyrrolidone (NMP).

Recently in animal experiments a developmentally toxic effect has been observed for N-methyl-2-pyrrolidone, and so efforts are now underway to find other solvents or solvent systems whose dissolution properties are similar to those of NMP and which at the same time are more advantageous from a toxicological and ecotoxicological standpoint.

Surprisingly it has now been found that caprolactam and caprolactam derivatives have good solvent properties and are able to dissolve a large number of active agrochemical substances/ingredients.

The invention provides compositions comprising
a) one or more active agrochemical ingredients and
b) one or more substances selected from caprolactam and caprolactam derivatives of the formula (I)

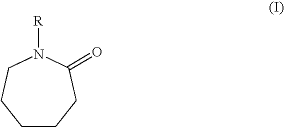

in which R is H, acetyl, benzoyl, allyl, vinyl, methyl, ethyl, n-propyl, isopropyl, benzyl, a polyethylene glycol ether unit which is attached via a carbon atom and has 1 to 30, preferably 1 to 10, and with particular preference 1 to 6 ethylene glycol units, or a polypropylene glycol ether unit which is attached via a carbon atom and has 1 to 30, preferably 1 to 10, and with particular preference 1 to 6 propylene glycol units.

In one preferred embodiment the compositions of the invention comprise
a) one or more active agrochemical ingredients and
b) acetylcaprolactam.

The active agrochemical ingredients may be selected for example

1. from the group of phosphorus compounds, preferably acephate, azamethiphos, azinphos-ethyl, azinphosmethyl, bromophos, bromophosethyl, cadusafos (F-67825), chlorethoxyphos, chlorfenvinphos, chlormephos, chlorpyrifos, chlorpyrifos-methyl, demeton, demeton-S-methyl, demeton-S-methyl sulfone, dialifos, diazinon, dichlorphos, dimethoate, disulfoton, EPN, ethion, ethoprophos, etrimfos, famphur, fenamiphos, fenitrothion, fensulfothion, fenthion, fonofos, formothion, fosthiazate (ASC-66824), heptenophos, isozophos, isothioate, isoxathion, malathion, methacrifos, methamidophos, methidathion, salithion, mevinphos, monocrotophos, naled, omethoate, oxydemeton-methyl, parathion, parathion-methyl, phenthoate, phorate, phosalone, phosfolan, phosphocarb (BAS-301), phosmet, phosphamidon, phoxim, pirimiphos, pirimiphos-ethyl, pirimiphos-methyl, profenofos, propaphos, proetamphos, prothiofos, pyraclofos, pyridaphenthion, quinalphos, sulprofos, temephos, terbufos, tebupirimfos, tetrachlorvinphos, thiodemeton, triazophos, trichlorphon, vamidothion;
2. from the group of carbamates, preferably
alanycarb (OK-135), aldicarb, 2-sec-butylphenyl methylcarbamate (BPMC), carbaryl, carbofuran, carbosulfan, cloethocarb, benfuracarb, ethiofencarb, furathiocarb, HCN-801, isoprocarb, methomyl, 5-methyl-m-cumenylbutyryl (methyl)carbamate, oxamyl, pirimicarb, propoxur, thiodicarb, thiofanox, 1-methylthio(ethylideneamino)-N-methyl-N-(morpholinothio)carbamate (UC 51717), triazamate;
3. from the group of carboxylic esters, preferably
acrinathrin, allethrin, alphametrin, beta-cypermethrin, 5-benzyl-3-furylmethyl (E)-(1R)-cis-2,2-dimethyl-3-(2-oxothiolan-3-ylidenemethyl)cyclopropanecarboxylate, beta-cyfluthrin, beta-cypermethrin, bioallethrin, bioallethrin (S)-cyclopentyl isomer, bioresmethrin, bifenthrin, (RS)-1-cyano-1-(6-phenoxy-2-pyridyl)methyl (1RS)-trans-3-(4-tert-butylphenyl)-2,2-dimethylcyclopropanecarboxylate (NCI 85193), cycloprothrin, cyfluthrin, cyhalothrin, cythrin, cypermethrin, cyphenothrin, deltamethrin, empenthrin, esfenvalerate, fenfluthrin, fenpropathrin, fenvalerate, flucythrinate, flumethrin, fluvalinate (D-isomer), imiprothrin (S-41311), lambda-cyhalothrin, permethrin, phenothrin ((R)-isomer), prallethrin, pyrethrins (natural products), resmethrin, tefluthrin, tetramethrin, theta-cypermethrin (TD-2344), tralomethrin, transfluthrin, zeta-cypermethrin (F-56701);
4. from the group of amidines, preferably
amitraz, chlordimeform;
5. from the group of tin compounds, preferably
cyhexatin, fenbutatin oxide; and
6. from further active agrochemical ingredients, preferably abamectin, ABG-9008, acetamiprid, agrapha falcitera, AKD-1022, AKD-3059, ANS-118, Bacillus thuringiensis, Beauveria bassianea, Bensultap, Bifenazate (D-2341), binapacryl, BJL-932, bromopropylate, BTG-504, BTG-505, buprofezin, camphechlor, cartap, chlorobenzilate, chlorfenapyr, chlorfluazuron, 2-(4-chlorophenyl)-4,5-diphenyl-thiophene (UBI-T 930), chlorofentezine, chromafenozide (ANS-118), CG-216, CG-217, CG-234, A-184699, 2-naphthylmethyl cyclopropanecarboxylate (Ro12-04770), cyromazin, diacloden (thiamethoxam), diafenthiuron, ethyl N-(3,5-dichloro-4-(1,1,2,3,3,3-hexafluoro-1-propyloxy)phenyl)carbamoyl)-2-chlorobenzcarboximidate, DDT, dicofol, diflubenzuron, N-(2,3-dihydro-3-methyl-1,3-thiazol-2-ylidene)-2,4-xylidine, dinobuton, dinocap, diofenolan, DPX-062, emamectin benzoate (MK-244), endosulfan, ethiprole (sulfethiprole), ethofenprox, etoxazole (YI-5301), fenazaquin, fenoxycarb, fipronil, fluazuron, flumite (flufenzine, SZI-121), 2-fluoro-5-(4-(4-ethoxyphenyl)-4-methyl-1-pentyl)diphenyl ether (MTI 800), granulosis and nuclear polyhedrosis viruses, fenpyroximate, fenthiocarb, flubenzimine, flucycloxuron, flufenoxuron, flufenprox (ICI-A5683), fluproxyfen, gamma-HCH, halofenozide (RH-0345), halofenprox (MTI-732), hexaflumuron (DE_{—}473), hexythiazox, HOI-9004, hydramethylnon (AC 217300), lufenuron, imidacloprid, indoxacarb (DPX-MP062), kanemite (AKD-2023), M-20, MTI-446, ivermectin, M-020, methoxyfenozide (intrepid, RH-2485), milbemectin, NC-196, Neemgard, nitenpyram (TI-304), 2-nitromethyl-4,5-dihydro-6H-thiazine (DS 52618), 2-nitromethyl-3,4-dihydrothiazole (SD 35651), 2-nitromethylene-1,2-thiazinan-3-ylcarbamaldehyde (WL108477), pyriproxyfen (S-71639), NC-196, NC-1111, NNI-9768, novaluron (MCW-275), OK-9701, OK-9601, OK-9602, propargite, pymetrozine, pyridaben, pyrimidifen (SU-8801), RH-0345, RH-2485, RYI-210, S-1283, S-1833, SB7242, SI-8601, silafluorfen, silomadine (CG-177), spinosad, SU-9118, tebufenozide, tebufenpyrad (MK-239), teflubenzuron, tetradifon, tetrasul, thiacloprid, thiocyclam, TI-435, tolfenpyrad (OMI-88), triazamate (RH-7988), triflumuron, verbutin, vertalec (Mykotal), YI-5301.

The active agrochemical ingredients included in the compositions of the invention are preferably selected from the group of pesticides, phytohormones, and herbicide safeners, more preferably from the group of pesticides and herbicide safeners, and with particular preference from pesticides.

Preferred pesticides are selected from herbicides, insecticides, fungicides, acaricides, bactericides, molluscicides, nematicides, and rodenticides.

Examples of preferred herbicides include the following substances: acetochlor; acifluorfen; aclonifen; AKH 7088, i.e., [[[1-[5-[2-chloro-4-(trifluoromethyl)-phenoxy]-2-nitrophenyl]-2-methoxyethylidene]amino]oxy] acetic acid and its methyl ester; alachlor; alloxydim; ametryn; amidosulfuron; amitrol; AMS, i.e., ammonium sulfamate; anilofos; asulam; atrazine; azimsulfurone (DPX-A8947); aziprotryn; barban; BAS 516H, i.e., 5-fluoro-2-phenyl-4H-3,1-benzoxazin-4-one; benazolin; benfluralin; benfuresate; bensulfuron-methyl; bensulide; bentazone; benzofenap; benzofluor; benzoylprop-ethyl; benzthiazuron; bialaphos; bifenox; bromacil; bromobutide; bromofenoxim; bromoxynil; bromuron; buminafos; busoxinone; butachlor; butamifos; butenachlor; buthidazole; butralin; butylate; cafenstrole (CH-900); carbetamide; cafentrazone (ICI-A0051); CDAA, i.e., 2-chloro-N,N-di-2-propenylacetamide; CDEC, i.e. 2-chloroallyl diethyldithio-carbamate; chlomethoxyfen; chloramben; chlorazifop-butyl, chlormesulon (ICI-A0051); chlorbromuron; chlorbufam; chlorfenac; chlorflurecol-methyl; chloridazon; chlorimuron ethyl; chlornitrofen; chlorotoluron; chloroxuron; chlorpropham; chlorsulfuron; chlorthal-dimethyl; clethodim; clodinafop and its ester derivatives (for example clodinafop-propargyl); clomazone; clomeprop; cloproxydim; clopyralid; cumyluron (JC 940); cyanazine; cycloate; cyclosulfamuron (AC 104); cycloxydim; cycluron; cyhalofop and its ester derivatives (for example butyl ester, DEH-112); cyperquat; cyprazine; cyprazole; 2,4-D and its salts (e.g., isoproylamine salt); daimuron; 2,4-DB; dalapon; desmedipham; desmetryn; di-allate; dicamba; dichlobenil; dichlorprop; diclofop and its esters such as diclofop-methyl; diethatyl; difenoxuron; difenzoquat; diflufenican; dimefuron; dimethachlor; dimethametryn; dimethenamid (SAN-582H); dimethazone, clomazon; dimethipin; dimetrasulfuron; dinitramine; dinoseb; dinoterb; diphenamid; dipropetryn; diquat; dithiopyr; diuron; DNOC; eglinazine-ethyl; EL 77, i.e., 5-cyano-1-(1,1-dimethylethyl)-N-methyl-1H-pyrazole-4-carboxamide; endothal; EPTC; esprocarb; ethafluralin; ethametsulfuron-methyl; ethidimuron; ethiozin; ethofumesate; F5231, i.e., N-[2-chloro-4-fluoro-5-[4-(3-fluoropropyl)-4,5-dihydro-5-oxo-1H-tetrazol-1-yl]phenyl]ethanesulfonamide; ethoxyfen and its esters (for example ethyl ester, HN-252); etobenzanid (HW 52); fenoprop; fenoxan, fenoxaprop and fenoxaprop-P and their esters, for example fenoxaprop-P-ethyl and fenoxaprop-ethyl; fenoxydim; fenuron; flamprop-methyl; flazasulfuron; fluazifop and fluazifop-P and their esters, for example fluazifop-butyl and fluazifop-P-butyl; fluchloralin; flumetsulam; flumeturon; flumiclorac and its esters (for example pentyl ester, S-23031); flumioxazin (S-482); flumipropyn; flupoxam (KNW-739); fluorodifen; fluoroglycofen-ethyl; flupropacil (UBIC-4243); fluridone; fluorochloridone; fluoroxypyr; flurtamone; fomesafen; fosamine; furyloxyfen; glufosinate; glyphosate; halosafen; halosulfuron and its esters (for example methyl ester, NC-319); haloxyfop and its esters; haloxyfop-P (=R-haloxyfop) and its esters; hexazinone; imazamethabenz-methyl; imazapyr; imazaquin and salts such as the ammonium salt; imazethamethapyr; imazethapyr; imazosulfuron; ioxynil; isocarbamid; isopropalin; isoproturon; isouron; isoxaben; isoxapyrifop; karbutilate; lactofen; lenacil; linuron; MCPA; MCPB; mecoprop; mefenacet; mefluidid; metamitron; metazachlor; methabenzthiazuron; metham; methazole; methoxyphenone; methyldymron; metabenzuron, methobenzuron; metobromuron; metolachlor; metosulam (XRD 511); metoxuron; metribuzin; metsulfuron-methyl; MH; molinate; monalide; monocarbamide dihydrogensulfate; monolinuron; monuron; MT 128, i.e., 6-chloro-N-(3-chloro-2-propenyl)-5-methyl-N-phenyl-3-pyridazinamine; MT 5950, i.e., N-[3-chloro-4-(1-methylethyl)phenyl]-2-methylpentanamide; naproanilide; napropamide; naptalam; NC 310, i.e., 4-(2,4-dichlorobenzoyl)-1-methyl-5-benzyloxypyrazole; neburon; nicosulfuron; nipyraclophen; nitralin; nitrofen; nitrofluorfen; norflurazon; orbencarb; oryzalin; oxadiargyl (RP-020630); oxadiazon; oxyfluorfen; paraquat; pebulate; pendimethalin; perfluidone; phenisopham; phenmedipham; picloram; piperophos; piributicarb; pirifenop-butyl; pretilachlor; primisulfuron-methyl; procyazine; prodiamine; profluralin; proglinazine-ethyl; prometon; prometryn; propachlor; propanil; propaquizafop and its esters; propazine; propham; propisochlor; propyzamide; prosulfalin; prosulfocarb; prosulfuron (CGA-152005); prynachlor; pyrazolinate; pyrazon; pyrazosulfuron-ethyl; pyrazoxyfen; pyridate; pyrithiobac (KIH-2031); pyroxofop and its esters (for example propargyl ester); quinclorac; quinmerac; quinofop and its ester derivatives, quizalofop and quizalofop-P and their ester derivatives for example quizalofop-ethyl; quizalofop-P-tefuryl and -ethyl; renriduron; rimsulfuron (DPX-E 9636); S 275, i.e., 2-[4-chloro-2-fluoro-5-(2-propynyloxy)phenyl]-4,5,6,7-tetrahydro-2H-indazole; secbumeton; sethoxydim; siduron; simazine; simetryn; SN 106279, i.e., 2-[[7-[2-chloro-4-(trifluoromethyl)phenoxy]-2-naphthalenyl]oxy]propanoic acid and its methyl ester; sulfentrazon (FMC-97285, F-6285); sulfazuron; sulfometuron-methyl; sulfosate (ICI-A0224); TCA; tebutam (GCP-5544); tebuthiuron; terbacil; terbucarb; terbuchlor; terbumeton; terbuthylazine; terbutryn; TFH 450, i.e., N,N-diethyl-3-[(2-ethyl-6-methylphenyl)sulfonyl]-1H-1,2,4-triazole-1-carboxamide; thenylchlor (NSK-850); thiazafluoron; thiazopyr (Mon-13200); thidiazimin (SN-24085); thifensulfuron-methyl; thiobencarb; tiocarbazil; tralkoxydim; tri-allate; triasulfuron; triazofenamide; tribenuron-methyl; triclopyr; tridiphane; trietazine; trifluralin; triflusulfuron and esters (for example methyl ester, DPX-66037); trimeturon; tsitodef; vernolate; WL 110547, i.e., 5-phenoxy-1-[3-(trifluoromethyl)phenyl]-1H-tetrazole; UBH-509; D-489; LS 82-556; KPP-300; NC-324; NC-330; KH-218; DPX-N8189; SC-0774; DOWCO-535; DK-8910; V-53482; PP-600; MBH-001; KIH-9201; ET-751; KIH-6127, and KIH-2023.

Examples of preferred fungicides include the following substances:

aldimorph, andoprim, anilazine, azoxystrobin, azaconazole, BAS 450f, benalaxyl, benodanil, benomyl, bethoxazin, binapacryl, Bion (CGA-245704), bitertanol, bromuconazole, buthiobate, captafol, captan, carbendazim, carboxin, carpropamide, CGA 173506, cymoxanil, cyprodinil, cyprofuram, diflumetorim, dichlofluanid, dichlomezin, diclobutrazol, diclocymet (S-2900), diclomezine, diethofencarb, difenoconazole (CGA 169374), difluconazole, dimethirimol, dimethomorph, diniconazole, dinocap, dithianon, dodemorph, dodine, edifenfos, epoxiconazole, ethirimol, etridiazole, famoxadone, (DPX-JE874), fenarimol, fenbuconazole, fenfuram, fenhexamid, fenpiclonil, fenpropidin, fenpropimorph, fentinacetate, fentinhydroxide, ferimzone (TF164), fluazinam, fluobenzimine, fludioxonil, flumetover (RPA-403397), fluquinconazole, fluorimide, flusilazole, flusulfamide, flutolanil, flutriafol, folpet, fosetylaluminium, fuberidazole, furalaxyl, furconazol, furametpyr (S-82658), furmecyclox, guazatine, hexaconazole, imazalil, imibenconazole, ipconazole, iprobenfos, iprodione, isoprothiolana, KNF 317, kresoxim-methyl (BAS-490F), copper compounds such as Cu oxychloride, oxine-Cu, Cu oxide, mancozeb, maneb, mepanipyrim (KIF 3535), mepronil, metalaxyl, metalaxyl-M (CGA-329351), metconazole, methasulfocarb, methfuroxam, metominofen (SSF-126), metominostrobin (fenominostrobin, SSF-126), MON 24000, MON-6550, MON-41100, myclobutanil, nabam, nitrothalisopropyl, nuarimol, ofurace, OK-9601, OK-9603, oxadixyl, oxycarboxin, paclobutrazol, penconazole, pencycuron, PP 969, polyoxins, probenazole, propineb, prochloraz, procymidon, propamocarb, propiconazole, prothiocarb, pyracarbolid, pyrazophos, pyrifenox, pyrimethanil, pyroquilon, quinoxyfen (DE-795), rabenzazole, RH-7592, RH-7281, sulfur, spiroxamine, SSF-109, tebuconazole, tetraconazole, TTF 167, thiabendazole, thicyofen, thifluzamide (RH-130753), thiophanate-methyl, thiram, TM402, tolclofos-methyl, tolylfluanid, triadimefon, triadimenol, triazoxide, Trichoderma harzianum (DHF471), tricyclazole, tridemorph, triflumizol, triforine, triflumizole (UCC-A815), triticonazole, uniconazole, validamycin, vinchlozolin, XRD 563, zineb, sodium dodecylsulfonates, sodium dodecyl sulfate, sodium C₁₃/C₁₅ alcohol ether sulfonate, sodium cetostearyl phosphate, sodium dioctylsulfosuccinate, sodium isopropylnaphthalenesulfonate, sodium methylenebisnaphthalenesulfonate, cetyltrimethylammonium chloride, salts of long-chain primary, secondary or tertiary amines, alkylpropyleneamines, laurylpyrimidinium bromide, ethoxylated quaternized fatty amines, alkyldimethylbenzylammonium chloride and 1-hydroxyethyl-2-alkylimidazoline.

Preferred phytohormones (plant hormones) are selected from auxins, preferably indole-3-acetic acid, methyl 4-chloroindole-3-acetate, 4-chloroindoleacetyl aspartate, substances from the group of the gibberellins (diterpenes) and cytokinins, growth-inhibiting phytohormones, preferably abscisic acid, xanthaxins, jasmonic acid, jasmonates, and ethylene donor substances, preferably L-methionine.

Herbicide safeners are substances which protect the crop plants against the action of herbicides. Preferred herbicide safeners are selected from 4-dichloroacetyl-3,4-dihydro-3-methyl-2H-1,4-benzoxazine (benzoxacor), cloquinfocet, dichlormid, fenclorim, herbicide safener AD-67, and mefenpyr-diethyl.

The compositions of the invention comprise with particular preference active agrochemical ingredients selected from flufenoxuron, pendimethalin, phenmedipham, prochloraz, tebuconazole, triforine, and 2,4-D in isopropylamine salt form.

The active agrochemical ingredients are designated either by the “common name” in accordance with the International Organization for Standardization (ISO) or by the chemical name, together where appropriate with a standard code number.

The compositions of the invention may further comprise surfactants, thickeners, antigellants, frost agents, solvents, dispersants, emulsifiers, preservatives, adjuvants, binders, antifoams, diluents, disintegrants, and wetters.

The weight ratio of component a):component b) in the compositions of the invention is preferably from 90:1 to 1:90, more preferably from 9:1 to 1:9, and with particular preference from 4:1 to 1:4.

In one preferred embodiment the compositions of the invention comprise one or more substances selected from nonionic, anionic, cationic, and amphoteric surfactants.

Preferred anionic surfactants are linear and branched alkyl sulfates, sulfonates, carboxylates, phosphates, sulfosuccinates, and taurates, alkyl ester sulfonates, arylalkylsulfonates, and alkyl ether sulfates.

Alkyl sulfates are water-soluble salts or acids of the formula ROSO₃M, in which R is preferably a C₁₀-C₂₄ hydrocarbon radical, more preferably an alkyl or hydroxyalkyl radical having 10 to 20 carbon atoms, and with particular preference a C₁₂-C₁₈ alkyl or hydroxyalkyl radical. M is hydrogen or a cation, preferably an alkali metal cation (e.g., sodium, potassium, lithium) or ammonium or substituted ammonium, e.g., a methyl-ammonium, dimethylammonium or trimethylammonium cation or a quaternary ammonium cation, such as tetramethylammonium and dimethylpiperidinium cation and quaternary ammonium cations derived from alkylamines such as ethylamine, diethylamine, triethylamine, and mixtures thereof.

The alkyl ether sulfates are water-soluble salts or acids of the formula RO(A)ₘSO₃M, in which R is preferably a C₁₀-C₂₄ alkyl or hydroxyalkyl radical, more preferably a C₁₂-C₂₀ alkyl or hydroxyalkyl radical, and with particular preference a C₁₂-C₁₈ alkyl or hydroxyalkyl radical. A is an ethoxy or propoxy unit, m is a number greater than 0, typically between 0.5 and 6, more preferably between 0.5 and 3, and M is a hydrogen atom or a cation, preferably a metal cation (e.g., sodium, potassium, lithium, calcium, magnesium, etc.), ammonium or a substituted ammonium cation. Examples of substituted ammonium cations are methyl-, dimethyl-, and trimethylammonium and quaternary ammonium cations such as tetramethylammonium and dimethylpiperidinium cations, and also those derived from alkylamines, such as ethylamine, diethylamine, triethylamine or mixtures thereof. Examples that may be mentioned include C₁₂-C₁₈ alkyl polyethoxylate (1.0) sulfate, C₁₂-C₁₈ alkyl polyethoxylate (2.25) sulfate, C₁₂-C₁₈ alkyl polyethoxylate (3.0) sulfate, and C₁₂-C₁₈ alkyl polyethoxylate (4.0) sulfate, the cation being sodium or potassium.

Likewise suitable are alkylsulfonates having linear or branched C₆-C₂₂ alkyl chains, examples being primary paraffinsulfonates, secondary paraffinsulfonates, alkylarylsulfonates, examples being linear alkylbenzenesulfonates with C₅-C₂₀ alkyl chains, alkylnaphthalenesulfonates, condensation products of naphthalenesulfonate and formaldehyde, lignosulfonate, alkyl ester sulfonates, i.e., sulfonated linear esters of C₈-C₂₀ carboxylic acids (i.e., fatty acids), C₈-C₂₄ olefinsulfonates, sulfonated polycarboxylic acids prepared by sulfonating the pyrolysis products of alkaline earth metal citrates.

Further suitable anionic surfactants are selected from alkylglycerol sulfates, fatty acylglycerol sulfates, oleylglycerol sulfates, alkylphenol ether sulfates, alkyl phosphates, alkyl ether phosphates, isethionates such as acylisethionates, N-acyltaurides, alkylsuccinamates, sulfosuccinates, monoesters of sulfosuccinates (especially saturated and unsaturated C₁₂-C₁₈ monoesters) and diesters of sulfosuccinates (especially saturated and unsaturated C₁₂-C₁₈ diesters), acylsarcosinates, sulfates of alkylpolysaccharides such as sulfates of alkylpolyglycosides, branched primary alkyl sulfates, and alkylpolyethoxycarboxylates such as those of the formula RO(CH₂CH₂O)ₖCH₂COO⁻M⁺ in which R is a C₈-C₂₂ alkyl group, k is a number from 0 to 10, and M⁺ is a soluble salt-forming cation.

In one preferred embodiment the weight ratio of the one or more compounds of the formula (I) to the one or more anionic surfactants is from 95:5 to 5:95, preferably from 80:20 to 20:80, more preferably from 80:20 to 70:30 or from 20:80 to 30:70.

Suitable nonionic surfactants include with preference fatty alcohol ethoxylates (alkylpolyethylene glycols), alkylphenol-polyethylene glycols, alkyl mercaptan-polyethylene glycols, fatty amine ethoxylates (alkylaminopolyethylene glycols), fatty acid ethoxylates (acylpolyethylene glycols), polypropylene glycol ethoxylates (e.g., Pluronics®), fatty acid alkylolamides (fatty acid amide-polyethylene glycols), N-alkyl- and N-alkoxypolyhydroxy-fatty acid amides, alkylpolysaccharides, sucrose esters, sorbitol esters, and polyglycol ethers.

Suitable amphoteric surfactants include with preference amphoacetates, more preferably monocarboxylates and dicarboxylates such as cocoamphocarboxy-propionate, cocoamidocarboxypropionic acid, cocoamphocarboxyglycinate (also referred to as cocoamphodiacetate), and cocoamphoacetate.

Cationic surfactants which can be used include di(C₁₀-C₂₄)alkyldimethylammonium chloride or bromide, preferably di(C₁₂-C₁₈)alkyldimethylammonium chloride or bromide; (C₁₀-C₂₄)alkyldimethylethylammonium chloride or bromide; (C₁₀-C₂₄)alkyltrimethylammonium chloride or bromide, preferably cetyltrimethylammonium chloride or bromide, and (C₂₀-C₂₂)alkyltrimethylammonium chloride or bromide; (C₁₀-C₂₄)alkyldimethylbenzylammonium chloride or bromide, preferably (C₁₂-C₁₈)alkyldimethylbenzylammonium chloride; N—(C₁₀-C₁₈)alkylpyridinium chloride or bromide, preferably N—(C₁₂-C₁₆)alkylpyridinium chloride or bromide; N—(C₁₀-C₁₈)alkylisoquinolinium chloride, bromide or monoalkyl sulfate; N—(C₁₂-C₁₈)alkylpolyoylaminoformylmethylpyridinium chloride; N—(C₁₂-C₁₈)alkyl-N-methylmorpholinium chloride, bromide or monoalkyl sulfate; N—(C₁₂-C₁₈)alkyl-N-ethylmorpholinium chloride, bromide or monoalkyl sulfate; (C₁₆-C₁₈)alkylpentaoxethylammonium chloride; diisobutylphenoxy-ethoxyethyldimethylbenzylammonium chloride; salts of N,N-diethylaminoethylstearylamide and oleylamide with hydrochloric acid, acetic acid, lactic acid, citric acid, phosphoric acid; N-acylaminoethyl-N,N-diethyl-N-methylammonium chloride, bromide or monoalkyl sulfate; and N-acylaminoethyl-N,N-diethyl-N-benzylammonium chloride, bromide or monoalkyl sulfate, with acyl standing preferably for stearyl or oleyl.

In one particularly preferred embodiment the compositions of the invention comprise one or more nonionic surfactants.

In one further particularly preferred embodiment the compositions of the invention comprise one or more anionic surfactants. Among these compositions preference is given in turn to those which comprise one or more anionic surfactants and one or more nonionic surfactants.

Thickeners which can be used include xanthan gum and/or cellulose, examples being carboxy-, methyl-, ethyl- or propylcellulose in the amounts by weight of 0.01% to 5%, based on the finished composition.

Suitable solvents include hydrocarbons, preferably aliphatic and aromatic hydrocarbons, examples being mineral oils, paraffins, alkylbenzenes, examples being toluene and xylene, naphthalene derivatives, especially 1-methylnaphthalene and 2-methylnaphthalene, (C₆-C₁₆)-aromatics mixtures, examples being the Solvesso series (ESSO) with the grades Solvesso® 100 (b.p. 162-177° C.), Solvesso® 150 (b.p. 187-207° C.) and Solvesso® 200 (b.p. 219-282° C.), (C₆-C₂₀)-aliphatics, which may be linear or cyclic, examples being the Shellsol series, grades T and K, or BP-n-paraffins, and also halogenated hydrocarbons, examples being tetrachloromethane, chloroform, chlorobenzene, chlorotoluene, methylene chloride, and dichloroethane, esters, such as triacetin (acetic acid triglyceride), butyrolactone, propylene carbonate, triethyl citrate and phthalic acid (C₁₂-C₂₂)alkyl esters, especially phthalic acid (C₄-C₈)alkyl esters, esters of polyalcohols, ethers, such as diethyl ether, tetrahydrofuran, dioxane, alkylene monoalkyl and dialkyl ethers such as propylene glycol monomethyl ether, propylene glycol monoethyl ether, ethylene glycol monomethyl or monoethyl ether, diglyme and tetraglyme, amides such as dimethylformamide, dimethylacetamide, di-n-butylformamide, dimethylcaprylic/capric fatty acid amide, and N-alkylpyrrolidone, ketones, such as acetone, cyclohexanone, isophorone, acetophenone, and methyl ethyl ketone, sulfoxides and sulfones such as dimethyl sulfoxide and sulfolane, polyglycols, animal oils, vegetable oils, and mineral oils.

In one preferred embodiment the compositions of the invention comprise besides caprolactam and/or caprolactam derivatives of the formula (I) one or more solvents in the amounts by weight from 0% to 98%, preferably form 5% to 80%, and more preferably from 10% to 50% by weight, based on the compositions.

In one further preferred embodiment of the invention the one or more solvents present besides caprolactam and/or caprolactam derivatives of the formula (I) in the compositions of the invention are selected from high-boiling aromatic solvents, preferably from aromatic solvents having a boiling point greater than 150° C.

In order to set the rheological properties of aqueous or solvent-containing emulsions or suspensions, the technical literature specifies a multiplicity of different systems. Examples of those known include cellulose ethers and other cellulose derivatives (e.g., carboxymethylcellulose, hydroxyethylcellulose), gelatin, starch and starch derivatives, sodium alginates, fatty acid polyethylene glycol esters, agar agar, tragacanth or dextrins. Synthetic polymers employed include various materials, such as polyvinyl alcohols, polacrylamides, polyvinylamides, polysulfonic acids, polyacrylic acid, polyacrylic esters, polyvinylpyrrolidone, polyvinyl methyl ether, polyethylene oxides, copolymers of maleic anhydride and vinyl methyl ether, and also various mixtures and copolymers of the compounds indicated above, including their various salts and esters. These polymers may alternatively be crosslinked or non-crosslinked.

Suitable dispersants and emulsifiers include adducts of 2 to 30 mol of ethylene oxide and/or 0 to 5 mol of propylene oxide with linear fatty alcohols having 8 to 22 carbon atoms, with fatty acids having 12 to 22 carbon atoms, and with alkylphenols having 8 to 15 carbon atoms in the alkyl group; C₁₂-C₁₈ fatty acid monoesters and diesters of adducts of 1 to 30 mol of ethylene oxide with glycerol; glycerol monoesters and diesters and sorbitan monoesters and diesters of saturated and unsaturated fatty acids having 6 to 22 carbon atoms and their ethylene oxide adducts; adducts of 15 to 60 mol of ethylene oxide with castor oil and/or hydrogenated castor oil; polyol esters and especially polyglycerol esters such as polyglycerol polyricinoleate and polyglycerol poly-12-hydroxystearate, for example. Likewise suitable are mixtures of compounds from two or more of these classes of substance. The adducts of ethylene oxide and/or propylene oxide with fatty alcohols, fatty acids, alkylphenols, glycerol monoesters and diesters, and sorbitan monoesters and diesters of fatty acids, or with castor oil, represent known products which are available commercially. They are mixtures of homologs whose average degree of alkoxylation corresponds to the ratio of the molar amounts of ethylene oxide and/or propylene oxide and substrate with which the addition reaction is carried out.

Further possible adjuvants include polyglycerol esters, alcohol ethoxylates, alkylpolysaccharides, fatty amine ethoxylates, sorbitan and sorbitol ethoxylate derivatives, and derivatives of alk(en)ylsuccinic anhydride. Also suitable are waxes, examples being montan wax acids, their soaps with monovalent and polyvalent cations, and montan wax esters of monohydric and polyhydric alcohols, carnauba wax, candelilla wax, sugarcane wax, peat wax, hydrocarbon compounds grafted and/or oxidized by various processes, and also alkoxylated waxes, as further adjuvants.

Preservatives which can be used include organic acids and their esters, examples being ascorbic acid, ascorbyl palmitate, sorbate, benzoic acid, methyl and propyl 4-hydroxy-benzoate, propionates, phenol, examples being 2-phenyl phenate, 1,2-benzisothiazolin-3-one, formaldehyde, sulfurous acid and salts thereof.

Suitable defoamers include polysilicones.

Frost preventatives available include ethylene glycol and propylene glycol.

As wetters it is possible to use alcohol ethoxylates/propoxylates.

It is possible for all compounds which are typical and can be used as low-temperature stabilizers to function for that purpose. Mention may be made by way of example of urea, glycerol, and propylene glycol.

Suitable buffers include all typical acids and their salts. By way of preference mention may be made of phosphate buffers, carbonate buffers, and citrate buffers.

The compositions of the invention possess a pH preferably of 3 to 11, more preferably of 6 to 8.

The compositions of the invention are in the form, preferably, of emulsifiable concentrates (EC), oil-in-water emulsions (EW), water-in-oil emulsions, soluble liquids (SL), suspoemulsions (SE), suspension concentrates (SC), suspensions, micro-emulsions (ME), dispersions, and compositions obtainable from the abovementioned compositions of the invention by dilution with water and/or solvents, preferably water.

In one preferred embodiment the compositions of the invention constitute water-free crop protection concentrates and water-containing oil-in-water or water-in-oil crop protection concentrates which can be used to produce aqueous spray liquors, and also aqueous SL (soluble liquid) formulations which can be used to increase the solubility of the active ingredient or ingredients. The soluble liquids contain preferably water but no other solvent.

In one particularly preferred embodiment the compositions of the invention constitute water-free concentrates and contain preferably up to 90%, more preferably 10% to 80%, and with particular preference 15% to 70% by weight of the one or more active agro-chemical ingredients or active agrochemical substances and preferably 1% to 99%, more preferably 5% to 90%, and with particular preference 5% to 70% by weight of the one or more substances selected from caprolactam and caprolactam derivatives of the formula (I).

In a further particularly preferred embodiment the compositions of the invention constitute water-containing concentrates, preferably in the oil-in-water or water-in-oil form, and contain preferably up to 50%, more preferably 10% to 45%, and with particular preference 20% to 40% by weight of the one or more active agrochemical ingredients or active agrochemical substances and preferably 1% to 50%, more preferably 5% to 30%, and with particular preference 5% to 20% by weight of the one or more substances selected from caprolactam and caprolactam derivatives of the formula (I).

In a further particularly preferred embodiment the compositions of the invention constitute aqueous SL (soluble liquid) formulations and contain preferably up to 60%, more preferably 10% to 50%, and with particular preference 20% to 50% by weight of the one or more active agrochemical ingredients or active agrochemical substances and preferably 1% to 15%, more preferably 2% to 12%, and with particular preference 2% to 8% by weight of the one or more substances selected from caprolactam and caprolactam derivatives of the formula (I).

With particular preference the compositions of the invention are in the form of emulsifiable concentrates (EC) and oil-in-water emulsions (EW). The emulsifiable concentrates (EC) are preferably water-free.

The emulsifiable concentrates (EC) can also be prepared easily by metering the active ingredients/substances into the initial charge of solvent or solvents, along with any further formulation components, and dissolving them with stirring.

In the context of the application of the emulsifiable concentrates (EC), the volumes required in each case are measured off, stirred into water, and applied to the field by spraying in the form of their dilute emulsions.

Emulsifiable concentrates, soluble liquids, suspoemulsions, and suspension concentrates are highly concentrated compositions which for application are diluted with water to the desired spray concentration. The dilution factor is preferably in the range from 10 to 1000, more preferably from 20 to 200. The use of the compositions of the invention raises the stability of the compositions on storage.

The amounts of pesticide, phytohormone and/or herbicide safener delivered per hectare are in the range from 0.1 to 5 kg, preferably 0.3 to 2.5 kg. The fraction of the solvent is in the range from 0.10 to 2.1 kg/ha. The volume of the formulation prepared for spray application is in the range from 30 to 1000 l/ha.

In one preferred embodiment the compositions of the invention comprise water. In one particularly preferred embodiment these compositions are in the form of spray liquors and contain, based on the overall spray liquor, 0.001% to 10%, preferably 0.025% to 3%, and more preferably 0.025% to 2% by weight of the one or more active agrochemical ingredients. In one especially preferred embodiment of the invention the spray liquors are prepared by dilution with water from the aforementioned concentrated compositions such as, for example, the water-free crop protection concentrates, the water-containing crop protection concentrates, present for example in oil-in-water or water-in-oil form, or the aqueous SL (soluble liquid) formulations, or alternatively from the other concentrated compositions specified above.

The compositions of the invention are advantageously suitable for example for checking and/or controlling weeds. The invention also further provides for the use of the compositions of the invention, preferably in the form of a spray liquor, for checking and/or controlling weeds.

The compositions of the invention are also suitable, moreover, for regulating the growth of plants. The invention accordingly further provides for the use of the compositions of the invention, preferably in the form of a spray liquor, for regulating the growth of plants.

The compositions of the invention are advantageously suitable, furthermore, for checking and/or controlling fungi. The invention accordingly further provides for the use of the compositions of the invention, preferably in the form of a spray liquor, for checking and/or controlling fungi.

Alternatively, the active agrochemical ingredients and the substances selected from caprolactam and caprolactam derivatives of the formula (I) may be present separately from one another at the time of their application, and may be mixed with one another not until a short time prior to their application, in a tank mix process, for example.

The present invention accordingly further provides for the use of
a) one or more active agrochemical ingredients and
b) one or more substances selected from caprolactam and caprolactam derivatives of the formula (I)

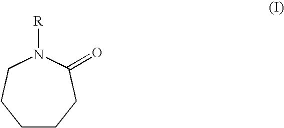

in which R is H, acetyl, benzoyl, allyl, vinyl, methyl, ethyl, n-propyl, isopropyl, benzyl, a polyethylene glycol ether unit which is attached via a carbon atom and has 1 to 30, preferably 1 to 10, and with particular preference 1 to 6 ethylene glycol units, or a polypropylene glycol ether unit which is attached via a carbon atom and has 1 to 30, preferably 1 to 10, and with particular preference 1 to 6 propylene glycol units for checking and/or controlling weeds, for regulating the growth of plants or for checking and/or controlling fungi.

The examples which follow serve to illustrate the invention in more detail, but without restricting it to them. All percentages are by weight.

### EXAMPLE 1

### Solubilities of Active Agrochemical Ingredients

The solubilities of various active agrochemical substances in acetylcaprolactam were determined by concentrating a starting solution containing 10% by weight active ingredient in stages at 25° C. The results are depicted in Table 1.

TABLE 1
Solubilities of active agrochemical substances in acetylcaprolactam

| Agrochemical active | Solubility (% by wt.) |
|---|---|
| substances | at 25° C. |
| flufenoxuron | 15-20 |
| pendimethalin | 60-65 |
| phenmedipham | 15-20 |
| prochloraz | 70-75 |
| tebuconazole | 30-35 |
| triforine | 15-20 |

### EXAMPLE 2

### Pendimethalin 450 EC

An emulsion concentrate with 450 g/l pendimethalin and acetylcaprolactam was prepared.

| | |
|---|---|
| Pendimethalin, tech. | 450 g |
| Solvesso 150 | 340 g |
| Acetylcaprolactam | 150 g |
| Emulsogen EL 400 | 45 g |
| Calsogen 4814 | 55 g |

External appearance of the formulation at 20° C., instantaneous: clear, no crystals

External appearance of the formulation at 20° C. after 14 days' storage at 54° C.: clear, no crystals

The concentrate from Example 2 was used to conduct an emulsion test. To form the emulsion, 95 parts by volume of water were charged to a 100 ml graduated cylinder and 5 parts by volume of the emulsifiable concentrate from Example 2 were added, and the emulsion was homogenized by closing the graduated cylinder and inverting it ten times. The results of the emulsion test are depicted in Table 2A.

TABLE 2A
Emulsion test on pendimethalin 450 g/l EC with acetylcaprolactam

| | |
|---|---|
| Emulsion test 1 day after preparing the EC | 5/95 |
| [vol. emulsifiable concentrate/vol. test water] | |
| Water hardness [ppm CaCO₃] | 500 |
| Temperature [° C.] | 30 |
| Spontaneity of emulsion formation | good |
| Separation after 1 h in ml | 0 |
| Separation after 2 h in ml | 0 |
| Separation after 6 h in ml | 0 |
| Crystallization | none |

### COMPARATIVE EXAMPLE 2

An emulsion concentrate with 450 g/l pendimethalin, but without acetylcaprolactam, was prepared.

| Pendimethalin, tech. | 450 g |
|---|---|
| Solvesso 150 | 422 g |
| Emulsogen IT | 150 g |
| Density (25° C.): | 1.022 |

External appearance of the formulation at 20° C., instantaneous: clear, no crystals

External appearance of the formulation at 20° C. after 14 days' storage at 54° C.: clear, copious crystal formation

The emulsifiable concentrate with 450 g/l pendimethalin but without acetylcaprolactam is not stable on storage and leads to crystal formation with a storage time of 14 days.

The concentrate from Comparative example 2 was used to conduct an emulsion test. To form the emulsion, 95 parts by volume of water were charged to a 100 ml graduated cylinder and 5 parts by volume of the emulsifiable concentrate from Comparative example 2 were added, and the emulsion was homogenized by closing the graduated cylinder and inverting it ten times. The results of the emulsion test are depicted in Table 2B.

TABLE 2B
Emulsion test on pendimethalin 450 g/l EC without acetylcaprolactam

| | |
|---|---|
| Emulsion test 1 day after preparing the EC | 5/95 |
| [vol. emulsifiable concentrate/vol. test water] | |
| Water hardness [ppm CaCO₃] | 500 |
| Temperature [° C.] | 30 |
| Spontaneity of emulsion formation | good |
| Separation after 1 h in ml | 0 |
| Separation after 2 h in ml | 0 |
| Separation after 6 h in ml | 0.5 cream |
| Crystallization | none |

The results from Table 2B show that after 6 hours 0.5 ml of cream had formed, i.e., a white, creamy deposit.

### EXAMPLE 3

### Flufenoxuron 100 EC

An emulsion concentrate with 100 g/l flufenoxuron and acetylcaprolactam was prepared.

| | |
|---|---|
| Flufenoxuron 97.9% | 102.1 g |
| Solvesso 200 ND | 646.4 g |
| Acetylcaprolactam | 168.2 g |
| Emulsogen EL 540 | 35.8 g |
| Calsogen AR 100 ND | 97.5 g |

External appearance of the formulation at 20° C., instantaneous: clear, no crystals

External appearance of the formulation at 20° C. after 14 days' storage at 54° C.: clear, no crystals

The concentrate from Example 3 was used to conduct an emulsion test. To form the emulsion, 95 parts by volume of water were charged to a 100 ml graduated cylinder and 5 parts by volume of the emulsifiable concentrate from Example 3 were added, and the emulsion was homogenized by closing the graduated cylinder and inverting it ten times. The results of the emulsion test are depicted in Table 3.

TABLE 3
Emulsion test on flufenoxuron 100 g/l EC with acetylcaprolactam

| | |
|---|---|
| Emulsion test 1 day after preparing the EC | 5/95 |
| [vol. emulsifiable concentrate/vol. test water] | |
| Water hardness [ppm CaCO₃] | 500 |
| Temperature [° C.] | 30 |
| Spontaneity of emulsion formation | good |
| Crystallization | none |

### COMPARATIVE EXAMPLE 3

An emulsion concentrate with 100 g/l flufenoxuron, but without acetylcaprolactam, was prepared.

| | |
|---|---|
| Flufenoxuron 97.9% | 102.1 g |
| Solvesso 200 ND | 814.6 g |
| Emulsogen EL 400 | 35.8 g |
| Calsogen AR 100 ND | 97.5 g |

External appearance of the formulation at 20° C., instantaneous: active ingredient does not dissolve completely

External appearance of the formulation at 20° C. after 14 days' storage at 54° C.: clear, copious crystal formation

The emulsifiable concentrate with 100 g/l flufenoxuron but without acetylcaprolactam is not stable on storage and leads to crystal formation with a storage time of 14 days.

### EXAMPLE 4

### Tebuconazole 250 EW

A concentrate with 250 g/l tebuconazole and acetylcaprolactam was prepared.

Tebuconazole 96.5% 259.0 g

| | |
|---|---|
| Acetylcaprolactam | 568.4 g |
| Water | 40.6 g |
| Emulsogen EP 4901 | 101.5 g |
| Emulsogen TS 200 | 20.3 g |
| Dispersogen TP 160 T | 18.7 g |

External appearance of the formulation at 25° C., instantaneous: clear, no crystals

External appearance of the formulation at 24° C., after 14 days' storage at 54° C.: clear, no crystals

External appearance of the formulation at 24° C., after 7 days' storage at −5° C.: clear, no crystals.

The concentrate from Example 4 was used to conduct an emulsion test. The emulsion was formed by charging 95 parts by volume of water to a 100 ml graduated cylinder and adding 5 parts by volume of the concentrate from Example 4, and by closing the graduated cylinder and homogenizing the emulsion by inverting the cylinder ten times. The results of the emulsion test are depicted in Table 4.

TABLE 4
Emulsion test on tebuconazole 250 EW

| | |
|---|---|
| Emulsion test 1 day after preparing the EC | 5/95 |
| [vol. of emulsifiable concentrate/vol. test water] | |
| Water hardness [ppm CaCO₃] | 500 |
| Temperature [° C.] | 30 |
| Spontaneity of emulsion formation | good-coarse |
| Separation after 1 h in ml | 0 |
| Separation after 2 h in ml | 0 |
| Separation after 6 h in ml | 0 |
| Crystallization | none |

The designation “coarse” means that the emulsion which had formed had coarse droplets.

With exclusive use of standard solvents for pesticide formulations, such as aromatic solvent mixtures such as Solvesso 150 or Solvesso 200, for example, i.e., without the use of the substances of component b) of the compositions of the invention, such as acetylcaprolactam, for example, tebuconazole cannot be dissolved completely at the concentration specified in Example 4. A corresponding formulation using these solvents alone, therefore, cannot be prepared.

### EXAMPLE 5

### 2,4-D IPA 300 SL

In the form of its amine salts, 2,4-dichlorophenoxyacetic acid tends to crystallize out of concentrated solutions. It is state of the art to use an approximately 5% addition of NMP in order to prevent crystallization. In the present example the isopropylamine salt of 2,4-dichlorophenoxyacetic acid was used, 2,4-D IPA for short.

Concentrated aqueous solutions of 2,4-D in isopropylamine salt form (350 g/l) were admixed with quantities of demineralized water and of the corresponding solvent addition such that the concentration of 2,4-D isopropylamine salt was 300 g/l and that of the solvent under test was 5% v/v. Then the external appearance, instantaneously (see column 2 of Table 5) and after storage at 0° C. (see column 3 of Table 5), and also the external appearance of a 5% (v/v) dilution in water (standard water according to CIPAC method D, containing 500 ppm CaCO₃), were observed and recorded (see columns 4 and 5 of Table 5). Particular emphasis was placed on any crystal formation. The results are depicted in Table 5.

TABLE 5
Influence of different solvent additions on the solubility behavior of
2,4-D isopropylamine salt

| | External | | | |
|---|---|---|---|---|
| | appearance of | External | | External |
| | formulation | appearance of | External | appearance |
| | [25° C.; | formulation | appearance | of dilution |
| Solvent addition | on day of | [after 48 hours | of dilution | [5% in water; |
| [5% by volume] | preparation] | at 0° C.] | [5% in water] | 24 hours, 30° C.] |
| N-Methylpyrrolidone | clear solution | clear solution | clear | clear solution, |
| (Merck K29502572 151) | | | | no crystals |
| Peractive LAC | clear solution | clear solution | clear | clear solution, |
| (DEAB 7A102) | | | | no crystals |
| Genagen 4296 | clear solution | clear solution | turbid | sample separated, |
| (DEGE 910595) | | | solution | crystal formation |
| | | | | <1% |
| Triethylene glycol | clear solution | clear solution | clear | clear solution, |
| dimethyl ether | | | | crystal formation |
| (DEGE 051642) | | | | >1% |
| Tetraethylene glycol | clear solution | clear solution | clear | clear solution, |
| dimethyl ether | | | | crystal formation |
| (DEGE 069013) | | | | <1% |
| Diethylene glycol | clear solution | clear solution | clear | turbid solution, |
| dibutyl ether | | | | crystal formation |
| (DEGE 077625) | | | | <1% |
| Dipropylene glycol | clear solution | clear solution | clear | clear solution, |
| dimethyl ether | | | | crystal formation |
| (DEGE 054826) | | | | <1% |

Under the conditions selected, Peractive LAC was the closest to NMP in terms of its behavior.

Chemical designation of the commercial products employed:

| | |
|---|---|
| Flufenoxuron | 1-[4-(2-chloro-α,α,α-trifluoro-p-tolyloxy)-2-fluorophenyl]- |
| | 3-(2,6-difluorobenzoyl)urea |
| Pendimethalin | N-(1-ethylpropyl)-3,4-dimethyl-2,6-dinitrophenylamine |
| Phenmedipham | 3-[(methoxycarbonylamino] phenyl(3-methylphenyl)- |
| | carbamate |
| Prochloraz | N-propyl-N-[2-(2,4,6-trichlorophenoxy)ethyl]-1H-imidazole- |
| | 1-carboxamide |
| Tebuconazole | R,S-1-p-chlorophenyl-4,4-dimethyl-3-(1H-1,2,4-triazol-1-yl- |
| | methyl)pentan-3-ol |
| Triforine | N,N′-[1,4-piperazinediylbis(2,2,2-trichloroethylidene)]bis- |
| | formamide |
| Solvesso 150 | aromatic hydrocarbons |
| Solvesso 200 ND | aromatic hydrocarbons |
| Calsogen 4814 | calcium alkylbenzenesulfonate in 2-ethylhexanol |
| Calsogen AR 100 ND | calcium alkylbenzenesulfonate in aromatic solvent |
| Dispersogen TP 160 T | polyaryl phenyl ether phosphate, triethanolamine salt |
| Emulsogen EL 400 | ethoxylated castor oil (40 mol EO) |
| Emulsogen EP 4901 | block polyalkoxylate (EO/PO block copolymer) |
| Emulsogen TS 200 | polyaryl phenyl polyglycol ether |
| Emulsogen EL 540 | ethoxylated castor oil (54 Mol EO) |
| Emulsogen IT | mixtures of ethoxylated castor oil and calcium |
| | alkylbenzenesulfonate in alcoholic solvent |
| Genagen 4296 | N,N-dimethylcapramide |
| Peractive LAC | acetylcaprolactam |

1. A composition comprising
a) at least one active agrochemical ingredient and
b) at least one substance of the formula (I) 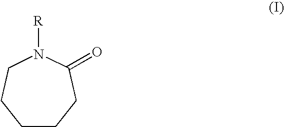
wherein R is acetyl.

2. The composition as claimed in claim 1, wherein the at least one active agrochemical ingredient is selected from the group consisting of pesticides, phytohormones, and herbicide safeners.

3. The composition as claimed in claim 2, wherein the at least one pesticide is selected from the group consisting of herbicides, insecticides, fungicides, acaricides, bactericides, molluscicides, nematicides, and rodenticides.

4. The composition as claimed in claim 2, wherein the at least one phytohormone is selected from the group consisting of auxins, substances from the group of the gibberellins (diterpenes) and cytokinins, growth-inhibiting phytohormones, and ethylene donor substances.

5. The composition as claimed in claim 2, wherein the at least one herbicide safener is selected from the group consisting of 4-dichloroacetyl-3,4-dihydro-3-methyl-2H-1,4-benzoxazine (benzoxacor), cloquinfocet, dichlormid, fenclorim, herbicide safener AD-67, and mefenpyr-diethyl.

6. The composition as claimed in claim 1, wherein the at least one active agrochemical ingredient is selected from the group consisting of flufenoxuron, pendimethalin, phenmedipham, prochloraz, tebuconazole, triforine, and 2,4-D in isopropylamine salt form.

7. The composition as claimed in claim 1, wherein the weight ratio of component a) to component b) is from 90:1 to 1:90.

8. The composition as claimed in claim 1, further comprising at least one substance selected from the group consisting of nonionic, anionic, cationic, and amphoteric surfactants.

9. The composition as claimed in claim 8, comprising at least one nonionic surfactant.

10. The composition as claimed in claim 8, comprising at least one anionic surfactant.

11. The composition as claimed in claim 1, further comprising at least one solvent in an amount from 0% to 98%, by weight based on the composition.

12. The composition as claimed in claim 11, wherein the at least one solvent is selected from the group consisting of high-boiling aromatic solvents.

13. The composition as claimed in claim 1, wherein the composition is a water-free concentrate and comprises up to 90%, by weight of the at least one active agrochemical ingredient and 1% to 99%, by weight of the at least one substance of the formula (I).

14. The composition as claimed in claim 1, wherein the composition is a water-containing concentrate, and comprises up to 50%, by weight of the at least one active agrochemical ingredient and 1% to 50%, by weight of the at least one substance of the formula (I).

15. The composition as claimed in claim 1, wherein the composition is an aqueous SL (soluble liquid) formulation and comprises up to 60%, by weight of the at least one active agrochemical ingredient and 1% to 15%, by weight of the at least one substance of the formula (I).

16. The composition as claimed in claim 1, further comprising water.

17. The composition as claimed in claim 16, wherein the composition is a spray liquor and comprises, based on the overall spray liquor, 0.001% to 10%, by weight of the at least one active agrochemical ingredient.

18. A process for preparing a spray liquor, comprising the step of diluting a composition as claimed in claim 13 with water.

19. A process for checking and/or controlling weeds, comprising the step of contacting the weeds with a composition according to claim 17.

20. A process for regulating the growth of plants, comprising the step of contacting the plants with a composition according to claim 17.

21. A process for checking and/or controlling fungi, comprising the step of contacting the fungi with a composition according to claim 17.

22. A process for checking and/or controlling weeds, for regulating the growth of plants, or for checking and/or controlling fungi, comprising the step of contacting the weeds, plants, and/or fungi with a composition, comprising
a) at least one active agrochemical ingredient and
b) at least one substance of the formula (I) 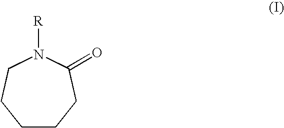
wherein R is acetyl.

23. The composition as claimed in claim 4, wherein the at least one phytohormone is selected from the group consisting of indole-3-acetic acid, methyl 4-chloroindole-3-acetate, and 4-chloroindoleacetyl aspartate.

24. The composition as claimed in claim 4, wherein the at least one growth-inhibiting phytohormone is selected from the group consisting of abscisic acid, xanthaxins, jasmonic acid, and jasmonates.

25. The composition as claimed in claim 4, wherein the at least one ethylene donor substance is selected from the group consisting of L-methionine.

26. The composition as claimed in claim 1, wherein the weight ratio of component a) to component b) is from 9:1 to 1:9.

27. The composition as claimed in claim 1, wherein the weight ratio of component a) to component b) is from 4:1 to 1:4.

28. The composition as claimed in claim 1, further comprising at least one solvent in an amount from 5% to 80%, by weight based on the composition.

29. The composition as claimed in claim 1, further comprising at least one solvent in an amount from 10% to 50%, by weight based on the composition.

30. The composition as claimed in claim 11, wherein the at least one solvent is selected from the group consisting of aromatic solvents having a boiling point greater than 150° C.

31. The composition as claimed in claim 13, wherein the composition is a water-free concentrate and comprises 10% to 80%, by weight of the at least one active agrochemical ingredient.

32. The composition as claimed in claim 13, wherein the composition is a water-free concentrate and comprises 15% to 70%, by weight of the at least one active agrochemical ingredient.

33. The composition as claimed in claim 13, wherein the composition is a water-free concentrate and comprises 5% to 90% by weight of the at least one substance of the formula (I).

34. The composition as claimed in claim 13, wherein the composition is a water-free concentrate and comprises 5% to 70% by weight of the at least one substance of the formula (I).

35. The composition as claimed in claim 14, wherein the composition is a water-containing concentrate in an oil-in-water form.

36. The composition as claimed in claim 14, wherein the composition is a water-containing concentrate in a water-in-oil form.

37. The composition as claimed in claim 14, wherein the composition is a water-containing concentrate, comprising 10% to 45% by weight of the at least one or more active agrochemical ingredient.

38. The composition as claimed in claim 14, wherein the composition is a water-containing concentrate, comprising 20% to 40% by weight of the at least one or more active agrochemical ingredient.

39. The composition as claimed in claim 14, wherein the composition is a water-containing concentrate, comprising 5% to 30% by weight of the at least one substance of the formula (I).

40. The composition as claimed in claim 14, wherein the composition is a water-containing concentrate, comprising 5% to 20% by weight of the at least one substance of the formula (I).

41. The composition as claimed in claim 15, wherein the composition is an aqueous SL (soluble liquid) formulation and comprises 10% to 50% by weight of the at least one active agrochemical ingredient.

42. The composition as claimed in claim 15, wherein the composition is an aqueous SL (soluble liquid) formulation and comprises 20% to 50% by weight of the at least one active agrochemical ingredient.

43. The composition as claimed in claim 15, wherein the composition is an aqueous SL (soluble liquid) formulation and comprises 2% to 12% by weight of the at least one substance of the formula (I).

44. The composition as claimed in claim 15, wherein the composition is an aqueous SL (soluble liquid) formulation and comprises 2% to 8% by weight of the at least one substance of the formula (I).

45. The composition as claimed in claim 16, wherein the composition is a spray liquor and comprises, based on the overall spray liquor, 0.025% to 3% by weight of the at least one active agrochemical ingredient.

46. The composition as claimed in claim 16, wherein the composition is a spray liquor and comprises, based on the overall spray liquor, 0.025% to 2% by weight of the at least one active agrochemical ingredient.

47. A process for preparing a spray liquor, comprising the step of diluting a composition as claimed in claim 14 with water.

48. A process for preparing a spray liquor, comprising the step of diluting a composition as claimed in claim 15 with water.

49. A spray liquor prepared by the process according to claim 18.

50. A spray liquor prepared by the process according to claim 47.

51. A spray liquor prepared by the process according to claim 48.
